(19) United States
(12) Patent Application Publication
(10) Pub. No.: US 2026/0066530 A1
(43) Pub. Date: Mar. 5, 2026

(54) ANTENNA AND COMMUNICATION DEVICE

(71) Applicant: HUAWEI TECHNOLOGIES CO., LTD., Shenzhen (CN)

(72) Inventors: Qingxia Zhang, Xi'an (CN); Libin Sun, Shanghai (CN); Chen Zhang, Xi'an (CN); Chengcheng Nie, Xi'an (CN)

(73) Assignee: HUAWEI TECHNOLOGIES CO., LTD., Shenzhen (CN)

(21) Appl. No.: 19/385,395

(22) Filed: Nov. 11, 2025

Related U.S. Application Data
(63) Continuation of application No. PCT/CN2024/077942, filed on Feb. 21, 2024.

(30) Foreign Application Priority Data
May 18, 2023 (CN) 202310568976.8

(51) Int. Cl. H01Q 1/52; H01Q 3/12

(52) U.S. Cl. CPC H01Q 1/521; H01Q 3/12

(57) ABSTRACT

An antenna and a communication device are provided. The antenna includes a first antenna element, a second antenna element, and a connection structure. The first antenna element and the second antenna element each have a feed point. The connection structure connects the first antenna element to the second antenna element. The connection structure is extendable in a direction perpendicular to a connection direction of the first antenna element and the second antenna element. The connection structure adjusts isolation between the first antenna element and the second antenna element through extension.

### CROSS-REFERENCE TO RELATED APPLICATIONS

This application is a continuation of International Application No. PCT/CN2024/077942, filed on Feb. 21, 2024, which claims priority to Chinese Patent Application No. 202310568976.8, filed on May 18, 2023. The disclosures of the aforementioned applications are hereby incorporated by reference in their entireties.

### TECHNICAL FIELD

This application relates to the field of communication technologies, and in particular, to an antenna and a communication device.

### BACKGROUND

Multiple-input multiple-output (MIMO) has advantages such as extremely high spectrum utilization, a high signal transmission rate, and high spatial efficiency. As a key technology of a wireless communication system, a MIMO antenna element implements a plurality of transmission channels by deploying a plurality of same antenna elements at a transmit end and a receive end, to effectively improve spectrum utilization, improve connection reliability, and increase a channel capacity.

However, with development of miniaturization of a terminal device, a distance between MIMO antenna elements is limited, and mutual coupling between antennas is strong. As a result, isolation between MIMO antennas is reduced, and performance of a MIMO system is greatly affected.

Therefore, how to decouple MIMO antenna elements that are close to each other and improve isolation between MIMO antennas becomes an urgent problem to be resolved.

### SUMMARY

This application provides an antenna and a communication device, to improve isolation between different antenna elements in the antenna.

According to a first aspect, this application provides an antenna. The antenna includes a first antenna element, a second antenna element, and a connection structure. The first antenna element and the second antenna element each have a feed point. The connection structure connects the first antenna element to the second antenna element. The connection structure is extendable in a direction perpendicular to a connection direction of the first antenna element and the second antenna element. The connection structure adjusts isolation between the first antenna element and the second antenna element through extension. In the antenna in this application, the connection structure connects the first antenna element to the second antenna element, and the connection structure is extendable in the direction perpendicular to the connection direction of the first antenna element and the second antenna element, to reduce coupling between the first antenna element and the second antenna element, so as to improve the isolation between the first antenna element and the second antenna element.

In some embodiments, the connection structure may include a first series stub and a second series stub. The first series stub and the second series stub are disposed in parallel, and two ends of each of the first series stub and the second series stub are respectively connected to the first antenna element and the second antenna element. A vertical distance between the first series stub and the second series stub is adjustable. Adjusting the vertical distance between the first series stub and/or the second series stub can implement extension of the connection structure in the direction perpendicular to the connection direction of the first antenna element and the second antenna element, to adjust the isolation between the first antenna element and the second antenna element.

Further, adjusting a size of the first series stub and/or a size of the second series stub, namely, a width of the first series stub and/or a width of the second series stub, can also change differential mode impedance of the antenna.

In some embodiments, the connection structure further includes a first parallel stub. One end of the first parallel stub is connected to the first series stub, and the other end of the first parallel stub is connected to the second series stub. A length of the first parallel stub in a vertical direction between the first series stub and the second series stub is adjustable. Adjusting the length of the first parallel stub in the vertical direction between the first series stub and the second series stub, for example, adjusting a position of the first parallel stub disposed between the first series stub and the second series stub, or adjusting the length of the first parallel stub in the vertical direction between the first series stub and the second series stub, or adjusting a width of the first parallel stub, can adjust common mode impedance between the first antenna element and the second antenna element, to adjust the isolation between the antenna elements.

In some embodiments, a first capacitor is further disposed on the first parallel stub, and a capacitance value of the first capacitor is adjustable. Adjusting a value of the first capacitor can adjust the common mode impedance between the first antenna element and the second antenna element.

The first antenna element may be a dipole antenna element. In this case, the first antenna element may include a first radiator, a second radiator, and a third radiator. A first end and a second end of the second radiator are respectively connected to the first radiator and the third radiator, and the first radiator and the third radiator are disposed in parallel on a same side of the second radiator. The feed point of the first antenna element is disposed on the second radiator. The second antenna element may also be a dipole antenna element. In this case, the second antenna element may include a fourth radiator. The fourth radiator and the second radiator are disposed in parallel, and the fourth radiator is located on a side that is of the second radiator and that is away from the first radiator and the third radiator. The feed point of the second antenna element is disposed on the fourth radiator. The two ends of each of the first series stub and the second series stub are respectively connected to the second radiator and the fourth radiator. In this disposing manner, the first antenna element and the second antenna element may be of an asymmetric structure.

In some embodiments, the antenna further includes a ground plane. The first antenna element and the second antenna element are connected to the ground plane through respective feed points. The connection structure includes a third series stub and a second parallel stub. Two ends of the third series stub are respectively connected to the first antenna element and the second antenna element. One end of the second parallel stub is connected to the third series stub, and the other end of the second parallel stub is connected to the ground plane. A length of the second parallel stub in a vertical direction from the third series stub to the ground plane is adjustable. Adjusting the length of the second parallel stub in the vertical direction from the third series stub to the ground plane can adjust the common mode impedance between the first antenna element and the second antenna element, to adjust the isolation between the first antenna element and the second antenna element.

In some embodiments, a second capacitor may be further disposed on the second parallel stub, and a capacitance value of the second capacitor is adjustable. Adjusting a value of the second capacitor can adjust the common mode impedance between the first antenna element and the second antenna element.

In some embodiments, the first antenna element may be a T-shaped antenna element. In this case, the first antenna element may include a fifth radiator, a sixth radiator, and a seventh radiator. One end of the fifth radiator is located at a first end of the sixth radiator, and one end of the seventh radiator is at a position between the first end and a second end of the sixth radiator. The seventh radiator and the fifth radiator are disposed in parallel and extend in opposite directions. The other end of the seventh radiator is connected to the ground plane through a feed point of the first antenna element. The second antenna element may also be a T-shaped antenna element. In this case, the second antenna element includes an eighth radiator, a ninth radiator, and a tenth radiator. One end of the ninth radiator is located at a first end of the eighth radiator, and one end of the tenth radiator is at a position between the first end of the eighth radiator and a second end of the eighth radiator. The ninth radiator and the tenth radiator are disposed in parallel and extend in a same direction. The other end of the tenth radiator is disposed to connect to the ground plane through a feed point of the second antenna element.

In some embodiments, the first antenna element may alternatively be a dual-band monopole antenna element. The first antenna element may include an eleventh radiator and a twelfth radiator. One end of the eleventh radiator and one end of the twelfth radiator are separately connected to the ground plane. The feed point of the first antenna element is disposed at a joint between the eleventh radiator and the ground plane. The second antenna element may also be a dual-band monopole antenna element. The second antenna element includes a thirteenth radiator and a fourteenth radiator. A first end of the thirteenth radiator is connected to the ground plane, and a second end of the thirteenth radiator is connected to the fourteenth radiator. The feed point of the second antenna element is disposed at a joint between the first end of the thirteenth radiator and the ground plane. The eleventh radiator is located between the twelfth radiator and the thirteenth radiator. The third series stub is connected to the thirteenth radiator and the eleventh radiator.

In the foregoing embodiment, the antenna may further include a slot antenna element, and the slot antenna element has a feed point. To adjust isolation between the slot antenna element and both the first antenna element and the second antenna element, the antenna may further include a defected ground structure. The defected ground structure is formed on the ground plane, and the defected ground structure is configured to adjust the isolation between the slot antenna element and both the first antenna element and the second antenna element.

According to a second aspect, this application further provides a communication device, including the antenna in any one of the technical solutions in the first aspect. When the antenna includes a first antenna element and a second antenna element, the first antenna element and the second antenna element may be respectively a wireless fidelity antenna element and a Bluetooth antenna element. Because the first antenna element is connected to the second antenna element through a connection structure, coexistence interference between the wireless fidelity antenna element and the Bluetooth antenna element can be reduced, so that the wireless fidelity antenna element and the Bluetooth antenna element are independent antennas, to improve a throughput rate of the wireless fidelity antenna element in a weak field. When the antenna further includes a slot antenna element and a defected ground structure, the slot antenna element may be a wireless fidelity antenna element.

Specifically, the communication device may be a smart screen, a notebook computer, or the like. When the communication device is a smart screen, the smart screen includes a main screen and a bracket. The bracket is configured to support the main screen. The antenna may be disposed on a side that is of the smart screen and that is close to the bracket.

### BRIEF DESCRIPTION OF DRAWINGS

FIG. 1a is a diagram of a structure of an antenna according to an embodiment of this application;

FIG. 1b is a diagram of a structure of an antenna according to an embodiment of this application;

FIG. 1c is a diagram of a structure of an antenna according to an embodiment of this application;

FIG. 1d is a diagram of a structure of an antenna according to an embodiment of this application;

FIG. 1e is a diagram of a structure of another antenna according to an embodiment of this application;

FIG. 1f is a diagram of a structure of an antenna in the conventional technology;

FIG. 2 is a chart of differential mode impedance and common mode impedance of the antenna in FIG. 1c;

FIG. 3a is a chart of common mode impedance of a first antenna element of the antenna in FIG. 1a;

FIG. 3b is a chart of differential mode impedance of a first antenna element of the antenna in FIG. 1a;

FIG. 4a is a chart of common mode impedance of the first antenna element of the antenna in FIG. 1e;

FIG. 4b is a chart of differential mode impedance of a first antenna element of the antenna in FIG. 1e;

FIG. 5a is a bandwidth effect diagram of the antennas in FIG. 1d, FIG. 1e, and FIG. 1f;

FIG. 5b is an effect diagram of isolation between a first antenna element and a second antenna element in the antennas in FIG. 1d, FIG. 1e, and FIG. 1f;

FIG. 6a is a diagram of a structure of another antenna according to an embodiment of this application;

FIG. 6b is a diagram of a structure of another antenna according to an embodiment of this application;

FIG. 6c is a diagram of a structure of another antenna in the conventional technology;

FIG. 7 is a chart of differential mode impedance and common mode impedance of the antenna in FIG. 6c;

FIG. 8a is a chart of common mode impedance of a first antenna element of the antenna in FIG. 6a;

FIG. 8b is a chart of differential mode impedance of a first antenna element of the antenna in FIG. 6a;

FIG. 9a is a chart of common mode impedance of the first antenna element of the antenna in FIG. 6b;

FIG. 9b is a chart of differential mode impedance of a first antenna element of the antenna in FIG. 6b;

FIG. 10a is a bandwidth effect diagram of the antennas in FIG. 6a, FIG. 6b, and FIG. 6c;

FIG. 10b is an effect diagram of isolation between a first antenna element and a second antenna element in the antennas in FIG. 6a, FIG. 6b, and FIG. 6c;

FIG. 11 is a diagram of a structure of another antenna according to an embodiment of this application;

FIG. 12 is a parameter diagram of isolation between a first antenna element and a second antenna element in FIG. 11 when a connection structure is removed and isolation between a first antenna element and a second antenna element in FIG. 11 when a connection structure is disposed;

FIG. 13 is a diagram of a structure of another antenna according to an embodiment of this application;

FIG. 14a is a parameter diagram of a first antenna element, a second antenna element, and a slot antenna element in FIG. 13;

FIG. 14b is a parameter diagram of isolation between a first antenna element, a second antenna element, and a slot antenna element in FIG. 13;

FIG. 15a is an efficiency parameter diagram of a first antenna element, a second antenna element, and a slot antenna element within a frequency band of 2.1 GHz to 3 GHz;

FIG. 15b is an efficiency parameter diagram of a first antenna element, a second antenna element, and a slot antenna element within a frequency band of 5.15 GHz to 5.85 GHz; and

FIG. 16 is a diagram of a structure of a communication device according to an embodiment of this application.

### REFERENCE NUMERALS

1: antenna; 10: first antenna element; 11: feed point of the first antenna element; 12: first radiator; 13: second radiator; 14: third radiator; 15: fifth radiator; 16: sixth radiator; 17: seventh radiator; 18: eleventh radiator; 19: twelfth radiator; 20: second antenna element; 21: feed point of the second antenna element; 22: fourth radiator; 23: eighth radiator; 24: ninth radiator; 25: tenth radiator; 26: thirteenth radiator; 27: fourteenth radiator; 30: connection structure; 31: first series stub; 32: second series stub; 33: first parallel stub; 330: first capacitor; 34: third series stub; 35: second parallel stub; 350: second capacitor; 40: ground plane; 50: defected ground structure; 60: slot antenna element; 61: end inductor; 62: feed stub; 620: third feed point; 70: main screen; and 80: bracket.

### DESCRIPTION OF EMBODIMENTS

To make the objectives, technical solutions, and advantages of this application clearer, the following further describes this application in detail with reference to the accompanying drawings.

Because of high channel capacity and high channel reliability, MIMO antennas are used in various wireless communication systems, for example, a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD), a universal mobile telecommunications system (UMTS), a worldwide interoperability for microwave access (WiMAX) communication system, a 5th generation (5G) mobile communication system or new radio (NR), a wireless local area network (WLAN) system, a wireless fidelity (Wi-Fi) system, a 6th generation (6G) communication system, and a future communication system. The 5G mobile communication system may be non-standalone (NSA) networking or standalone (SA) networking.

Isolation is a ratio of transmit power of an antenna element to receive power of another antenna element, and a unit may be dB. Isolation between antennas quantitatively represents a degree of coupling between antenna elements. A larger value of the isolation indicates a lower degree of mutual interference between two antenna elements. However, in MIMO antennas, because of a limitation of placement space, antenna elements are adjacent to each other, resulting in poor isolation between antennas.

To improve poor isolation between MIMO antennas, a symmetric mode cancellation method is usually used in the conventional technology. However, in the symmetric mode cancellation method, a structure of the MIMO antenna, an antenna feed structure, and an ambient environment of the antenna need to be completely symmetric. However, in general, the structure of the MIMO antenna cannot be completely symmetric, and the symmetric mode cancellation method cannot be applied to a MIMO antenna of any structure.

In view of this, based on a mode cancellation technology, this application provides an asymmetric MIMO antenna structure. Based on the antenna structure in this application, a decoupling technology is implemented in tight coupling of the MIMO antenna structure by using a mode cancellation method, to improve isolation between antennas. Herein, the asymmetric MIMO antenna structure in this application includes an antenna asymmetric in terms of an antenna structure, an antenna asymmetric in terms of feeding, an antenna asymmetric in terms of an environment, and the like.

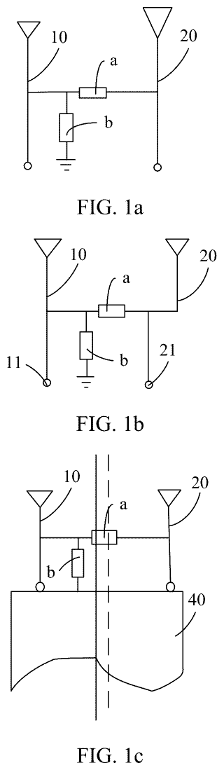

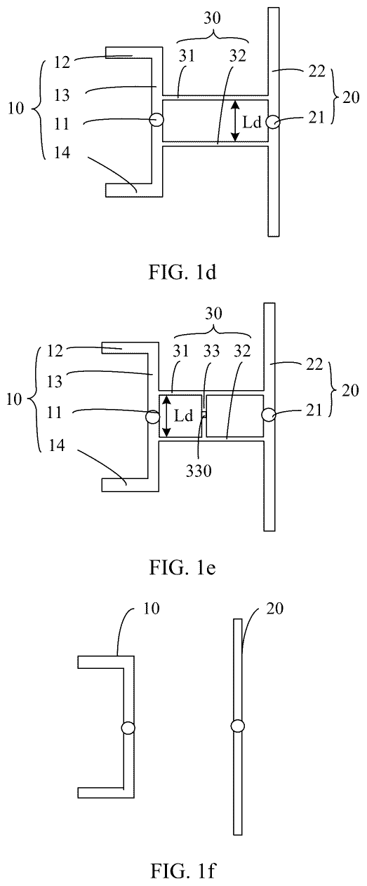

Refer to FIG. 1a, FIG. 1b, and FIG. 1c. FIG. 1a is a diagram of an antenna asymmetric in terms of an antenna structure. It can be learned that structures of a first antenna element 10 and a second antenna element 20 are different. FIG. 1b is a diagram of an antenna asymmetric in terms of feeding. It can be learned that structures of the first antenna element 10 and the second antenna element 20 are the same, but feeding structures are different. FIG. 1c is a diagram of an antenna asymmetric in terms of an environment. It can be learned that an entirety formed by the first antenna element 10 and the second antenna element 20 is located on a ground plane 40, a symmetry axis of the first antenna element 10 and the second antenna element 20 is a vertical dashed line, and a symmetry axis of the ground plane 40 is a vertical solid line. The solid line and the dashed line do not overlap. In other words, the entirety formed by the first antenna element 10 and the second antenna element 20 is asymmetric in terms of an environment relative to the ground plane 40. In FIG. 1a, FIG. 1b, and FIG. 1c, a is a series circuit connected in series between two antenna elements, and b is a parallel circuit connected in parallel between the series circuit and the ground.

Terms used in the following embodiments are merely intended to describe specific embodiments, but are not intended to limit this application.

Reference to “some embodiments” or the like described in this specification indicates that one or more embodiments of this application include a specific feature, structure, or characteristic described with reference to embodiments. Therefore, the statements such as “in some embodiments”, “in some other embodiments”, and “in other embodiments” that appear at different locations in this specification do not necessarily refer to a same embodiment, but mean “one or more but not all embodiments”, unless otherwise specifically emphasized in another manner. The terms “include”, “contain”, “have”, and their variants all mean “include but are not limited to”, unless otherwise specifically emphasized in another manner.

FIG. 1d is a diagram of a structure of an antenna according to an embodiment of this application. Refer to FIG. 1d. The antenna provided in this application includes a first antenna element 10, a second antenna element 20, and a connection structure 30. The first antenna element 10 has a feed point 11 of the first antenna element, the second antenna element 20 has a feed point 21 of the second antenna element, and the connection structure 30 connects the first antenna element 10 to the second antenna element 20. The connection structure 30 connects the first antenna element 10 to the second antenna element 20. The connection structure 30 is extendable in a direction perpendicular to a connection direction of the first antenna element 10 and the second antenna element 20. The connection structure 30 adjusts isolation between the first antenna element 10 and the second antenna element 20 through extension. Specifically, the connection structure 30 connects the first antenna element 10 to the second antenna element 20, and the connection structure 30 extends or retracts in the direction perpendicular to the connection direction of the first antenna element 10 and the second antenna element 20, to reduce coupling between the first antenna element 10 and the second antenna element 20, so as to improve the isolation between the first antenna element 10 and the second antenna element 20.

In the foregoing embodiment, the first antenna element 10 and the second antenna element 20 have a plurality of structural forms. For example, the first antenna element 10 is one of a dipole antenna element, a planar inverted F antenna element, a patch antenna element, a T-shaped antenna element, or a dual-band monopole antenna element. The second antenna element 20 is also one of a dipole antenna element, a planar inverted F antenna element, a patch antenna element, a T-shaped antenna element, or a dual-band monopole antenna element.

In an embodiment, both the first antenna element 10 and the second antenna element 20 are dipole antenna elements. Still refer to FIG. 1d. The first antenna element 10 includes a first radiator 12, a second radiator 13, and a third radiator 14. A first end of the second radiator 13 is connected to the first radiator 12, a second end of the second radiator 13 is connected to the third radiator 14, and the first radiator 12 and the third radiator 14 are disposed on a same side of the second radiator 13 in parallel. A feed point 11 of the first antenna element is disposed between the first end and the second end of the second radiator 13. The second antenna element 20 includes a fourth radiator 22, and the fourth radiator 22 is located on a side that is of the second radiator 13 and that is away from the first radiator 12 and the third radiator 14. A feed point 21 of the second antenna element is disposed on the fourth radiator 22. The connection structure 30 includes a first series stub 31 and a second series stub 32. Two ends of the first series stub 31 are respectively connected to the second radiator 13 and the fourth radiator 22. Two ends of the second series stub 32 are respectively connected to the second radiator 13 and the fourth radiator 22. In addition, a vertical distance between the first series stub 31 and the second series stub 32 is adjustable, that is, a spacing Ld in FIG. 1d is adjusted. When the feed point 11 of the first antenna element and the feed point 21 of the second antenna element are fed in phase, the spacing Ld between the first series stub 31 and the second series stub 32 is adjusted, so that the connection structure 30 is extendable in the direction perpendicular to the connection direction of the first antenna element 10 and the second antenna element 20, that is, differential mode impedance between the first antenna element 10 and the second antenna element 20 can be adjusted, and coupling between the first antenna element 10 and the second antenna element 20 is reduced. This improves the isolation between the first antenna element 10 and the second antenna element 20.

Specifically, when the spacing between the first series stub 31 and the second series stub 32 is adjusted, positions at which the first series stub 31 is connected to the second radiator 13 and the fourth radiator 22 may be adjusted, to adjust the spacing Ld between the first series stub 31 and the second series stub 32 in an extension direction of the second radiator 13. Alternatively, positions at which the second series stub 32 is connected to the second radiator 13 and the fourth radiator 22 may be adjusted, to adjust the spacing Ld between the first series stub 31 and the second series stub 32 in the extension direction of the second radiator 13. In addition, the positions at which the first series stub 31 and the second series stub 32 are connected to the second radiator 13 and the fourth radiator 22 may be adjusted at the same time, to adjust the spacing Ld between the first series stub 31 and the second series stub 32 in the extension direction of the second radiator.

In addition, a width of the first series stub 31 may be adjusted. The width of the first series stub 31 may be understood as a length in the direction perpendicular to the connection direction of the first antenna element 10 and the second antenna element 20. Alternatively or in addition, a width of the second series stub 32 may be adjusted. The width of the second series stub 32 may be understood as a length in the direction perpendicular to the connection direction of the first antenna element 10 and the second antenna element 20.

In the foregoing descriptions, regardless of whether the vertical distance between the first series stub 31 and the second series stub 32 is adjusted or whether the width of the first series stub 31 and/or the width of the second series stub 32 is adjusted, it is equivalent to adjusting a value of a resistance in a series circuit in FIG. 1a and/or FIG. 1b, to adjust the differential mode impedance between the first antenna element 10 and the second antenna element 20.

It should be noted that, when the first radiator 12, the second radiator 13, and the third radiator 14 are specifically disposed, the first radiator 12 and the third radiator 14 may be perpendicular to the second radiator 13, and the first radiator 12, the second radiator 13, and the third radiator 14 are of an integrated structure. When the fourth radiator 22 is disposed, the fourth radiator 22 and the second radiator 13 are disposed in parallel.

FIG. 1e is a diagram of a structure of another antenna according to an embodiment of this application. Refer to FIG. 1e. The connection structure 30 further includes a first parallel stub 33, and the first parallel stub 33 is disposed between the first series stub 31 and the second series stub 32. When the feed point 11 of the first antenna element on the first antenna element 10 and the feed point 21 of the second antenna element on the second antenna element 20 are fed out of phase, the first parallel stub 33 is disposed at a current small point of the first series stub 31 and the second series stub 32. A width of the first parallel stub 33 is adjusted. The width herein may be understood as a length in the connection direction of the first antenna element 10 and the second antenna element 20. Adjusting the length of the first parallel stub 33 in the connection direction of the first antenna element 10 and the second antenna element 20, equivalent to adjusting a value of a resistance in a parallel circuit in FIG. 1a and/or FIG. 1b, can also adjust common mode impedance between the first antenna element 10 and the second antenna element 20, so that the first antenna element 10 and the second antenna element 20 are decoupled. This improves the isolation between the first antenna element 10 and the second antenna element 20. When a relative position between the first series stub 31 and the second series stub 32 changes, a length Ld of the first parallel stub 33 in a vertical direction between the first series stub 31 and the second series stub 32 is adjustable.

Still refer to FIG. 1e. A first capacitor 330 may be disposed on the first parallel stub 33. Adjusting a value of the first capacitor 330 can also adjust the common mode impedance between the first antenna element 10 and the second antenna element 20, so that the first antenna element 10 and the second antenna element 20 are decoupled. This improves the isolation between the first antenna element 10 and the second antenna element 20.

Still refer to FIG. 1d and FIG. 1e. A sum of lengths of the first radiator 12, the second radiator 13, and the third radiator 14 may be 45 mm, and a length of the fourth radiator 22 may be 45 mm. A spacing between the first antenna element 10 and the second antenna element 20 may be 0.2λ (20 mm).

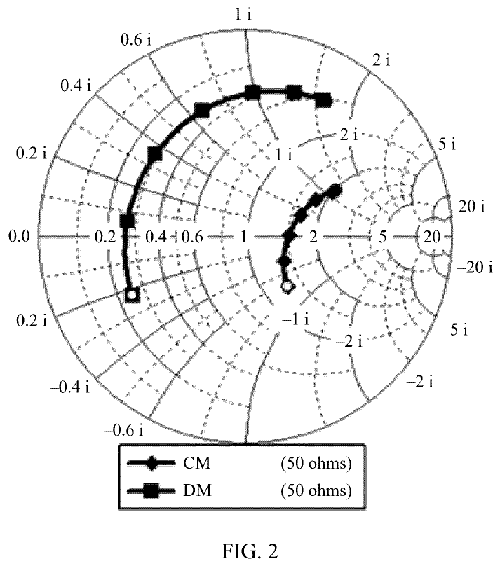

The following further describes effect of disposing the connection structure when the first antenna element and the second antenna element are dipole antennas, where CM is a common mode, and DM is a differential mode. FIG. 1f is a diagram of a structure of an antenna in which no connection structure is disposed. FIG. 2 is a chart of differential mode impedance and common mode impedance of the first antenna element when the feed point of the first antenna element and the feed point of the second antenna element on the first antenna element and the second antenna element in FIG. 1f are fed in phase and fed out of phase. It can be learned from FIG. 2 that when a connection structure is disposed between the first antenna element and the second antenna element, both common mode impedance and differential mode impedance of the first antenna element deviate from 50 ohms.

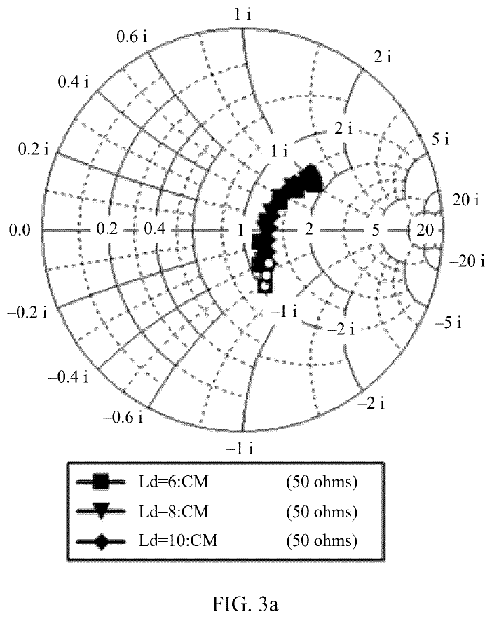

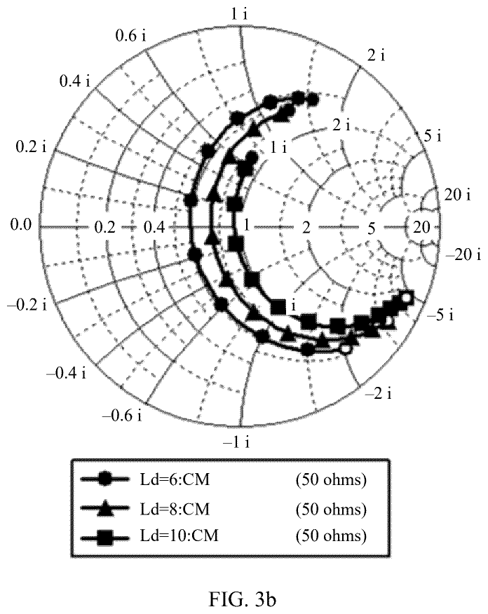

FIG. 3a is a chart of common mode impedance of the first antenna element when the feed point of the first antenna element and the feed point of the second antenna element on the first antenna element and the second antenna element in FIG. 1d are fed out of phase after the first series stub and the second series stub are disposed between the first antenna element and the second antenna element. Refer to FIG. 1d and FIG. 3a. When the feed point 11 of the first antenna element and the feed point 21 of the second antenna element are fed out of phase, the spacing between the first series stub 31 and the second series stub 32 is adjusted. To be specific, in a process in which the spacing Ld between the first series stub 31 and the second series stub 32 increases from 6 mm to 8 mm and then increases from 8 mm to 10 mm, the common mode impedance of the first antenna element 10 is close to 50 ohms. FIG. 3b is a chart of differential mode impedance of the first antenna element when the feed point of the first antenna element and the feed point of the second antenna element on the first antenna element and the second antenna element in FIG. 1d are fed in phase after the first series stub and the second series stub are disposed between the first antenna element and the second antenna element. Refer to FIG. 1d and FIG. 3b. When the first feed point 11 and the feed point 21 of the second antenna element are fed in phase, the spacing between the first series stub 31 and the second series stub 32 is adjusted. To be specific, in a process in which the spacing Ld between the first series stub 31 and the second series stub 32 increases from 6 mm to 8 mm and then increases from 8 mm to 10 mm, the differential mode impedance of the first antenna element 10 gradually increases. When Ld is 10 mm, the differential mode impedance of the first antenna element 10 is close to 50 ohms, so that coupling between the first antenna element 10 and the second antenna element 20 is reduced. This improves the isolation between the first antenna element 10 and the second antenna element 20.

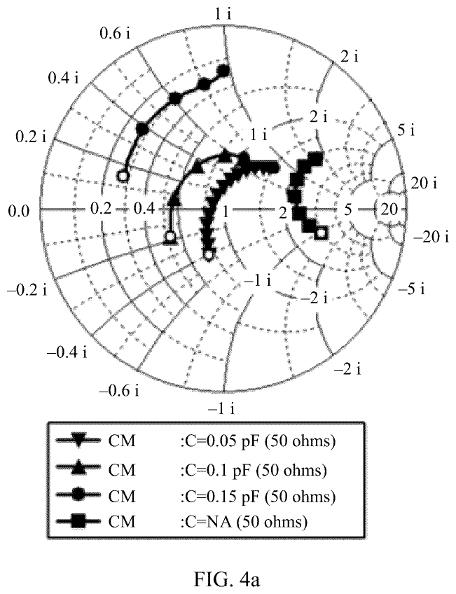

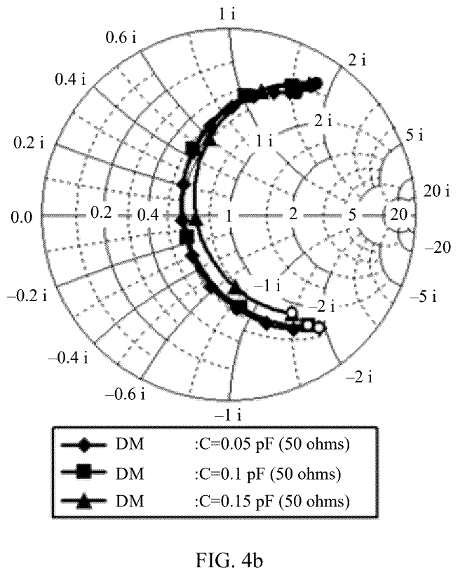

FIG. 4a is a chart of common mode impedance of the first antenna element when the first capacitor is disposed on the first parallel stub between the first series stub and the second series stub in FIG. 1e, and the feed point 11 of the first antenna element and the feed point 21 of the second antenna element on the first antenna element and the second antenna element are fed out of phase. Refer to FIG. 1e and FIG. 4a. When the feed point 11 of the first antenna element and the feed point 21 of the second antenna element are fed out of phase, and the first capacitor 330 is not disposed on the first parallel stub 33 (C=NA), the common mode impedance of the first antenna element 10 is large. When the first capacitor 330 is disposed on the first parallel stub 33, and the value of the first capacitor 330 on the first parallel stub 33 is adjusted, the common mode impedance of the first antenna element 10 may be adjusted. Specifically, when the value of the first capacitor 330 gradually increases, the common mode impedance of the first antenna element 10 gradually decreases, and when the first capacitor 330 is 0.05 pF, the common mode impedance of the first antenna element 10 is close to 50 ohms. FIG. 4b is a chart of differential mode impedance of the first antenna element when the first capacitor is disposed on the first parallel stub between the first series stub and the second series stub in FIG. 1e, and the feed point of the first antenna element and the feed point of the second antenna element on the first antenna element and the second antenna are fed in phase. Refer to FIG. 1e and FIG. 4b. When the feed point 11 of the first antenna element and the feed point 21 of the second antenna element are fed in phase, and the value of the first capacitor 330 on the first parallel stub 33 gradually increases, the differential mode impedance of the first antenna element 10 is close to 50 ohms, so that coupling between the first antenna element 10 and the second antenna element 20 is reduced. This improves the isolation between the first antenna element 10 and the second antenna element 20.

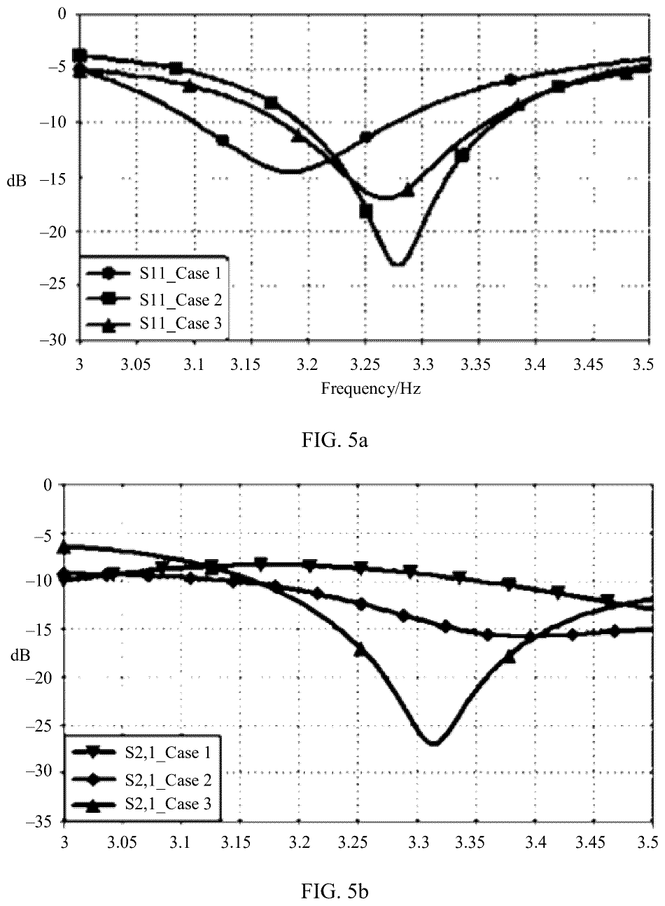

FIG. 5a is a bandwidth effect diagram of an antenna with a connection structure added and an antenna without a connection structure added. In FIG. 5a, a case 1 is a bandwidth parameter diagram of the antenna when no connection structure is disposed (namely, a bandwidth parameter diagram of the antenna in FIG. 1f), a case 2 is a bandwidth parameter diagram of the antenna when the first series stub and the second series stub are disposed (namely, a bandwidth parameter diagram of the antenna in FIG. 1d), and a case 3 is a bandwidth parameter diagram of the antenna when the first series stub, the second series stub, and the first parallel stub are disposed (namely, a bandwidth parameter diagram of the antenna in FIG. 1e). It can be learned from FIG. 5a that a bandwidth of the antenna basically remains unchanged compared with the antenna without a connection structure disposed. FIG. 5b is an effect diagram of the isolation between the first antenna element and the second antenna element after the connection structure is added to the antenna. In FIG. 5b, a case 1 is a parameter diagram of isolation between the first antenna element and the second antenna element in the antenna when no connection structure is disposed (namely, a parameter diagram of isolation between antennas in FIG. 1c), a case 2 is a parameter diagram of isolation between the first antenna element and the second antenna element in the antenna when the first series stub and the second series stub are disposed (namely, a parameter diagram of isolation between antennas in FIG. 1d), and a case 3 is a parameter diagram of isolation between the first antenna element and the second antenna element in the antenna when the first series stub, the second series stub, and the first parallel stub are disposed (namely, a parameter diagram of isolation between antennas in FIG. 1e). It can be learned from FIG. 5b that under a condition of 3.3 GHz, the isolation between the first antenna element and the second antenna element in the antenna when no connection structure is disposed is 9 dB, the isolation between the first antenna element and the second antenna element in the antenna when the first series stub and the second series stub are disposed is 14 dB, and the isolation between the first antenna element and the second antenna element in the antenna when the first series stub, the second series stub, and the first parallel stub are disposed and the first capacitor is disposed on the first parallel stub is 25 dB. This indicates that disposing the first series stub, the second series stub, and the first parallel stub in the antenna can effectively improve the isolation between the first antenna element and the second antenna element.

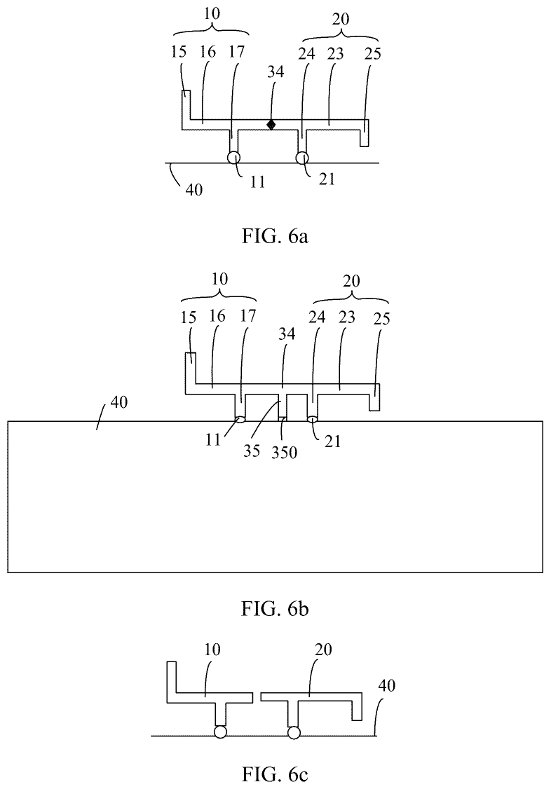

FIG. 6a is a diagram of a structure of another antenna according to an embodiment of this application. Refer to FIG. 6a. When both the first antenna element 10 and the second antenna element 20 in this application are T-shaped antenna elements, the connection structure includes a third series stub 34, and the antenna further includes a ground plane 40. The first antenna element 10 includes a fifth radiator 15, a sixth radiator 16, and a seventh radiator 17. The sixth radiator 16 has a first end and a second end. One end of the fifth radiator 15 is located at the first end of the sixth radiator 16. One end of the seventh radiator 17 is at a position between the first end and the second end of the sixth radiator 16. The seventh radiator 17 and the fifth radiator 15 extend in opposite directions. The seventh radiator 17 and the fifth radiator 15 are disposed in parallel. The other end of the seventh radiator 17 is connected to the ground plane 40 through the feed point 11 of the first antenna element. The second antenna element 20 includes an eighth radiator 23, a ninth radiator 24, and a tenth radiator 25. The eighth radiator 23 has a first end and a second end. One end of the ninth radiator 24 is located at the first end of the eighth radiator 23. One end of the tenth radiator 25 is at a position between the first end and the second end of the eighth radiator 23. The ninth radiator 24 and the tenth radiator 25 extend in a same direction. The ninth radiator 24 and the tenth radiator 25 are disposed in parallel. The other end of the tenth radiator 25 is connected to the ground plane 40 through the feed point 21 of the second antenna element. The second end of the sixth radiator 16 is connected to the second end of the eighth radiator 23 through the third series stub 34. Specifically, when the feed point 11 of the first antenna element and the feed point 21 of the second antenna element are fed in phase, adjusting a width of the third series stub 34, that is, adjusting the value of the resistance in the series circuit in FIG. 1b and/or FIG. 1c, or adjusting a spacing between the third series stub 34 and the ground plane 40, can adjust the differential mode impedance between the first antenna element 10 and the second antenna element 20, where the width of the third series stub 34 may be understood as a length in the direction perpendicular to the connection direction of the first antenna element 10 and the second antenna element 20. This improves the isolation between the first antenna element 10 and the second antenna element 20.

It should be noted that, when the fifth radiator 15, the sixth radiator 16, and the seventh radiator 17 are specifically disposed, the fifth radiator 15 and the seventh radiator 17 may be perpendicular to the sixth radiator 16. When the eighth radiator 23, the ninth radiator 24, and the tenth radiator 25 are disposed, the ninth radiator 24 and the tenth radiator 25 are also perpendicular to the eighth radiator 23.

FIG. 6b is a diagram of a structure of another antenna according to an embodiment of this application. Refer to FIG. 6b. The connection structure further includes a second parallel stub 35. One end of the second parallel stub 35 is connected to the third series stub 34, and the other end of the second parallel stub 35 is connected to the ground plane 40. When the first antenna element 10 and the second antenna element 20 are fed out of phase, the second parallel stub 35 is disposed at a current small point of the third series stub 34. Adjusting a width of the second parallel stub 35, that is, adjusting the value of the resistance in the parallel circuit in FIG. 1b and/or FIG. 1c, can adjust the common mode impedance between the first antenna element 10 and the second antenna element 20, so that coupling between the first antenna element 10 and the second antenna element 20 is reduced, where the width herein may be understood as a length in the direction perpendicular to the connection direction of the first antenna element 10 and the second antenna element 20. This improves the isolation between the first antenna element 10 and the second antenna element 20. When the spacing between the third series stub 34 and the ground plane 40 is adjusted, a length of the second parallel stub 35 in a vertical direction from the third series stub 34 to the ground plane 40 is adjustable.

Still refer to FIG. 6b. A second capacitor 350 may be disposed on the second parallel stub 35. Adjusting a value of the second capacitor 350 can also adjust the common mode impedance between the first antenna element 10 and the second antenna element 20, so that the first antenna element 10 and the second antenna element 20 are decoupled. This improves the isolation between the first antenna element 10 and the second antenna element 20.

A sum of lengths of the fifth radiator 15, the sixth radiator 16, and the seventh radiator 17 is 25 mm, and lengths of the eighth radiator 23, the ninth radiator 24, and the tenth radiator 25 are 25 mm. In addition, based on disposition forms of the fifth radiator 15, the sixth radiator 16, and the seventh radiator 17, and disposition forms of the eighth radiator 23, the ninth radiator 24, and the tenth radiator 25, the first antenna element 10 and the second antenna element 20 are asymmetric T-shaped antennas. The spacing between the first antenna element 10 and the second antenna element 20 is 0.14λ (14 mm).

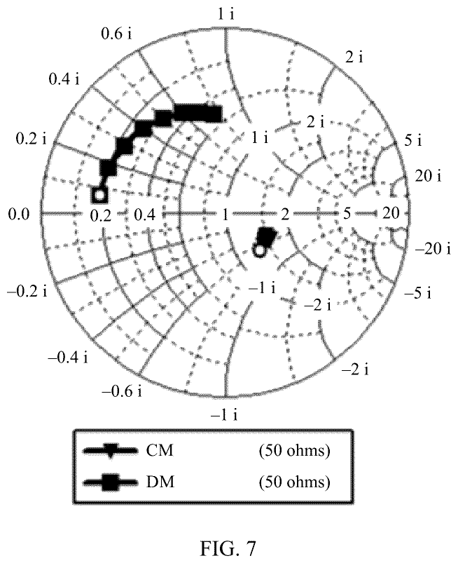

The following further describes effect of disposing the connection structure when the first antenna element and the second antenna element are T-shaped antennas. FIG. 6c is a diagram of a structure of an antenna in which no connection structure is disposed. A CM is a common mode, and a DM is a differential mode. FIG. 7 is a chart of differential mode impedance and common mode impedance of the first antenna element when the feed point of the first antenna element and the feed point of the second antenna element on the first antenna element and the second antenna element in FIG. 6c are fed in phase and fed out of phase. Refer to FIG. 7. When the connection structure is disposed between the first antenna element and the second antenna element, both the common mode impedance and the differential mode impedance of the first antenna element deviate from 50 ohms.

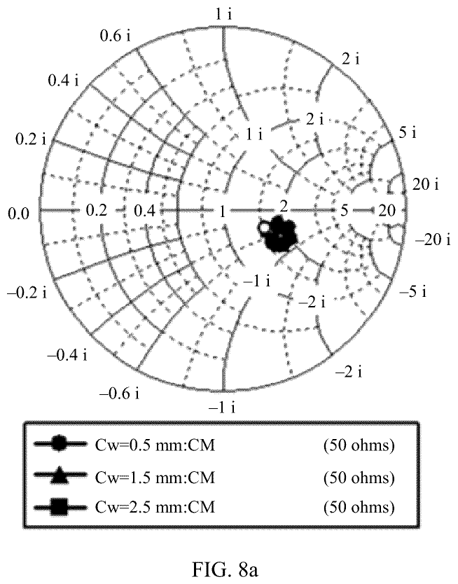

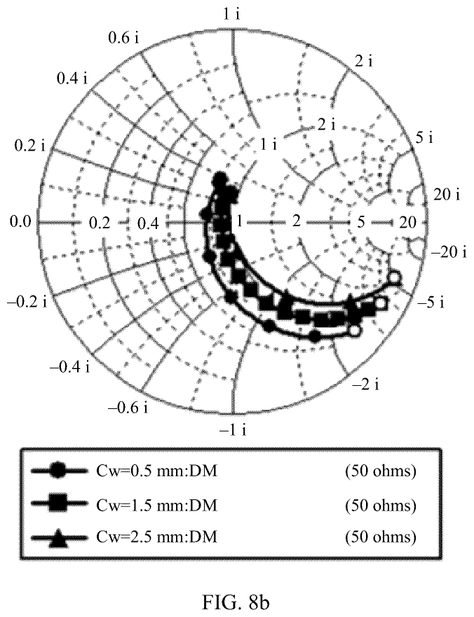

FIG. 8a is a chart of common mode impedance of the first antenna element when the feed point of the first antenna element and the feed point of the second antenna element on the first antenna element and the second antenna element are fed out of phase after the third series stub is disposed between the first antenna element and the second antenna element in FIG. 6a. Refer to FIG. 6a and FIG. 8a. When the feed point 11 of the first antenna element and the feed point 21 of the second antenna element are fed out of phase, the width of the third series stub 34 is adjusted, and the common mode impedance of the first antenna element 10 is basically close to 50 ohms. Specifically, Cw is the width of the second series stub. When the width of the second series stub increases from 0.5 mm to 2.5 mm, the common mode impedance of the first antenna element 10 basically remains unchanged. FIG. 8b is a chart of differential mode impedance of the first antenna element when the feed point of the first antenna element and the feed point of the second antenna element on the first antenna element and the second antenna element are fed in phase after the third series stub is disposed between the first antenna element and the second antenna element in FIG. 6a. Refer to FIG. 6a and FIG. 8b. When the first feed point 11 and the feed point 21 of the second antenna element are fed in phase, adjusting the width of the third series stub 34 can adjust the differential mode impedance of the first antenna element 10. Specifically, when the width of the third series stub 34 increases from 0.5 mm to 2.5 mm, the differential mode of the first antenna element 10 gradually increases and is close to 50 ohms, so that coupling between the first antenna element 10 and the second antenna element 20 is reduced. This improves the isolation between the first antenna element 10 and the second antenna element 20.

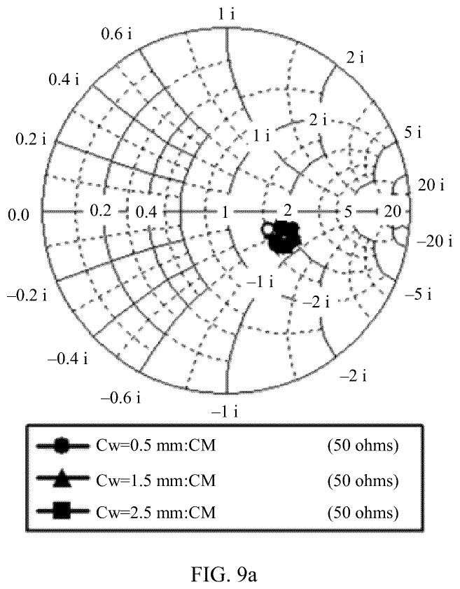

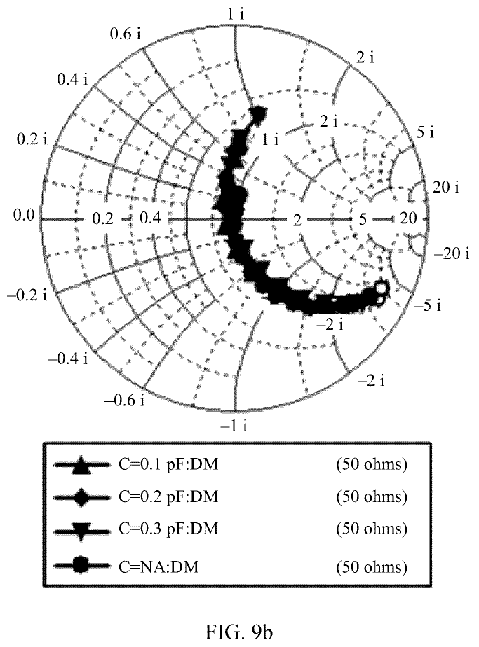

FIG. 9a is a chart of common mode impedance of the first antenna element when the second capacitor is disposed on the second parallel stub disposed between the first antenna element and the second antenna element in FIG. 6b, and the feed point 11 of the first antenna element and the feed point 21 of the second antenna element on the first antenna element and the second antenna element are fed out of phase. Refer to FIG. 6b and FIG. 9a. When the feed point 11 of the first antenna element and the feed point 21 of the second antenna element are fed out of phase, and the second capacitor 350 (C=NA) is not disposed on the second parallel stub 35, the common mode impedance of the first antenna element 10 is large. When the second capacitor 350 is disposed on the second parallel stub 35, and the value of the second capacitor 350 on the second parallel stub 35 is adjusted, the common mode impedance of the first antenna element 10 can be adjusted. Specifically, when the value of the second capacitor 350 gradually increases, the common mode impedance of the first antenna element 10 gradually decreases, and when the second capacitor 350 is 0.1 pF, the common mode impedance of the first antenna element 10 is close to 50 ohms. FIG. 9b is a chart of differential mode impedance of the first antenna element when the second capacitor is disposed on the second parallel stub disposed between the first antenna element and the second antenna element in FIG. 6b, and the feed point of the first antenna element and the feed point of the second antenna element on the first antenna element and the second antenna element are fed in phase. Refer to FIG. 6b and FIG. 9b. When the feed point 11 of the first antenna element and the feed point 21 of the second antenna element are fed in a same phase, and the value of the second capacitor 350 on the second parallel stub 35 gradually increases, the differential mode impedance of the first antenna element 10 is close to 50 ohms, so that coupling between the first antenna element 10 and the second antenna element 20 is reduced. This improves the isolation between the first antenna element 10 and the second antenna element 20.

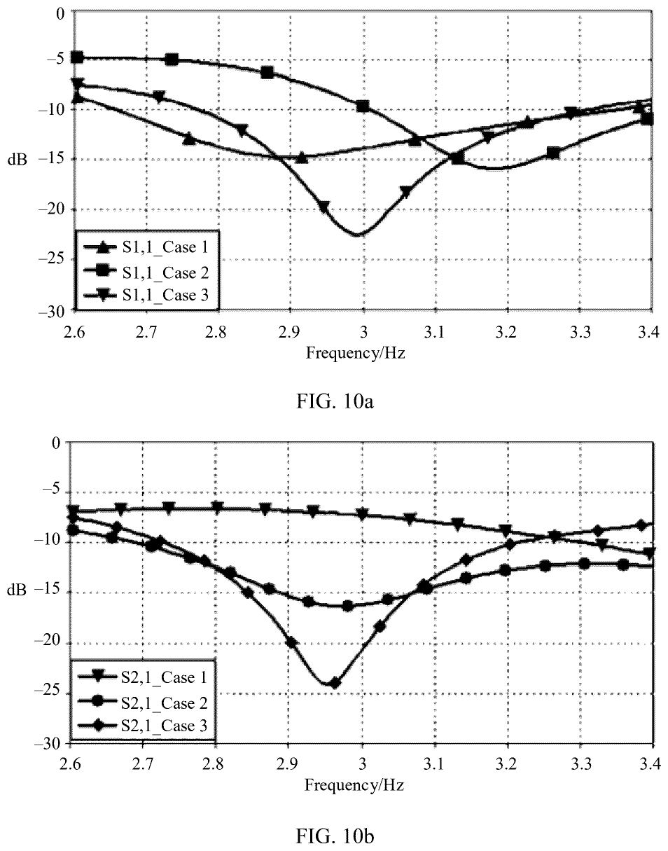

FIG. 10a is a bandwidth effect diagram of an antenna with a connection structure added and an antenna without a connection structure added. In FIG. 10a, a case 1 is a bandwidth parameter diagram of the antenna when no connection structure is disposed (namely, a bandwidth parameter diagram of the antenna in FIG. 6c), a case 2 is a bandwidth parameter diagram of the antenna when the third series stub is disposed in the antenna (namely, a bandwidth parameter diagram of the antenna in FIG. 6a), and a case 3 is a bandwidth parameter diagram of the antenna when the third series stub and a second parallel stub are disposed in the antenna (namely, a bandwidth parameter diagram of the antenna in FIG. 6b). It can be learned from FIG. 10a that a bandwidth of the antenna basically remains unchanged compared with the antenna without a connection structure disposed. FIG. 10b is an effect diagram of the isolation between the first antenna element and the second antenna element after the connection structure is added to the antenna. In FIG. 10b, a case 1 is a parameter diagram of isolation between the first antenna element and the second antenna element in the antenna when no connection structure is disposed (namely, a parameter diagram of isolation between antennas in FIG. 6c), a case 2 is a parameter diagram of isolation between the first antenna element and the second antenna element in the antenna when the third series stub is disposed (namely, a parameter diagram of isolation between antennas in FIG. 6a), and a case 3 is a parameter diagram of isolation between the first antenna element and the second antenna element in the antenna when the third series stub and the second parallel stub are disposed (namely, a parameter diagram of isolation between antennas in FIG. 6b). It can be learned from FIG. 10b that, under a condition of 3 GHz, the isolation between the first antenna element and the second antenna element in the antenna when no connection structure is disposed is 7 dB, the isolation between the first antenna element and the second antenna element in the antenna when only the third series stub is disposed is 16 dB, and the isolation between the first antenna element and the second antenna element in the antenna when the third series stub and the second parallel stub are disposed and the second capacitor is disposed on the second parallel stub is 20 dB. This indicates that disposing the third series stub and the second parallel stub in the antenna can effectively improve the isolation between the first antenna element and the second antenna element.

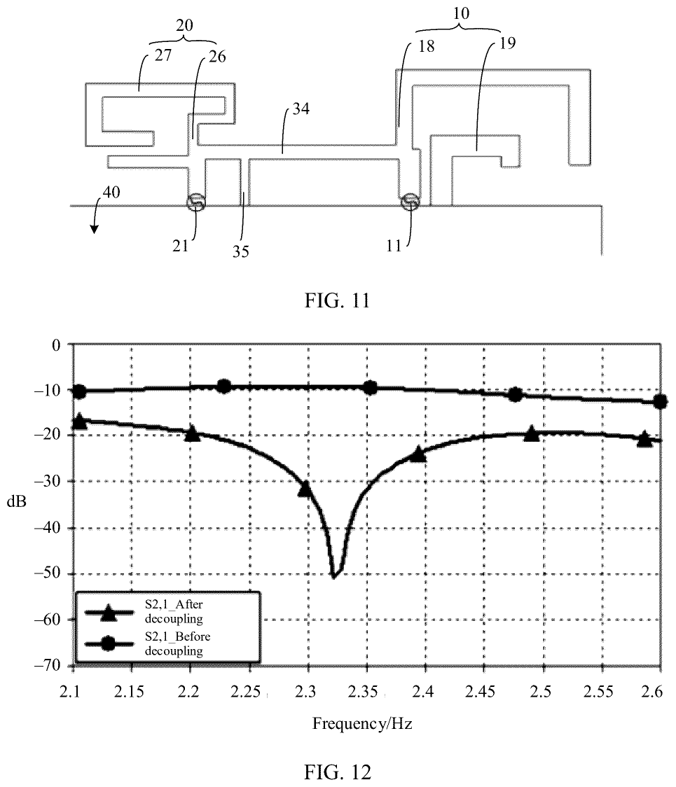

FIG. 11 is a diagram of a structure of another antenna according to an embodiment of this application. Refer to FIG. 11. When the first antenna element and the second antenna element in this application are dual-band monopole antenna elements, the spacing between the first antenna element and the second antenna element is 13.7 mm (0.11λ, where λ is a wavelength of a low-frequency 2.4 G resonance frequency). The connection structure includes a third series stub and a second parallel stub. The antenna further includes a ground plane 40. The first antenna element 10 includes an eleventh radiator 18 and a twelfth radiator 19. The eleventh radiator 18 may generate a 2.4 G resonance, and the twelfth radiator 19 may generate a 5.5 G resonance. One end of the eleventh radiator 18 and one end of the second radiator 19 are separately connected to the ground plane 40. The feed point 11 of the first antenna element is disposed at a joint between the eleventh radiator 18 and the ground plane 40. The second antenna element 20 includes a thirteenth radiator 26 and a fourteenth radiator 27. The thirteenth radiator 26 may generate a 5.5 G resonance, and the fourteenth radiator 27 may generate a 2.4 G resonance. A first end of the thirteenth radiator 26 is connected to the ground plane 40, and a second end of the thirteenth radiator 26 is connected to the fourteenth radiator 27. The feed point 21 of the second antenna element is disposed at a joint between the first end of the thirteenth radiator 26 and the ground plane 40. The eleventh radiator 18 is located between the thirteenth radiator 26 and the twelfth radiator 19. The third series stub 34 is connected to the thirteenth radiator 26 and the eleventh radiator 18. One end of the second parallel stub 35 is connected to the third series stub 34, and the other end of the second parallel stub 35 is connected to the ground plane 40. Adjusting the width of the third series stub 34, that is, adjusting the value of the resistance in the series circuit in FIG. 1c, can change an overall structure of the antenna, to adjust impedance of the antenna, where the width of the third series stub 34 may be understood as a length in the direction perpendicular to the connection direction of the first antenna element 10 and the second antenna element 20. This further improves the isolation between the first antenna element 10 and the second antenna element 20.

Specifically, when the feed point 11 of the first antenna element and the feed point 21 of the second antenna element are fed out of phase, changing the width of the third series stub 34 or changing a spacing between the third series stub 34 and the ground plane 40 can adjust differential mode impedance of the antenna. When the feed point 11 of the first antenna element and the feed point 21 of the second antenna element are fed in phase, changing a connection position of the second parallel stub 35 or adjusting the width of the second parallel stub 35, that is, adjusting the value of the resistance in the parallel circuit in FIG. 1c or adjusting a capacitance value of the second parallel stub 35, can adjust common mode impedance of the antenna, where the width may be understood as a length in the direction perpendicular to the connection direction of the first antenna element 10 and the second antenna element 20.

To further describe effect of disposing the connection structure when the first antenna element and the second antenna element are dual-band monopole antenna elements, FIG. 12 is a parameter diagram of isolation between the first antenna element and the second antenna element in an antenna having a connection structure and isolation between the first antenna element and the second antenna element in an antenna having no connection structure according to an embodiment of this application. In FIG. 12, “Before decoupling” is a simulation line when no connection structure is disposed, and “After decoupling” is a simulation line when a connection structure is disposed. Refer to FIG. 12. Compared with that of an antenna on which no fourth series stub and a third parallel stub are disposed, isolation, at a low frequency, of an antenna on which a fourth series stub and a third parallel stub are disposed increases from 10 dB to 20 dB.

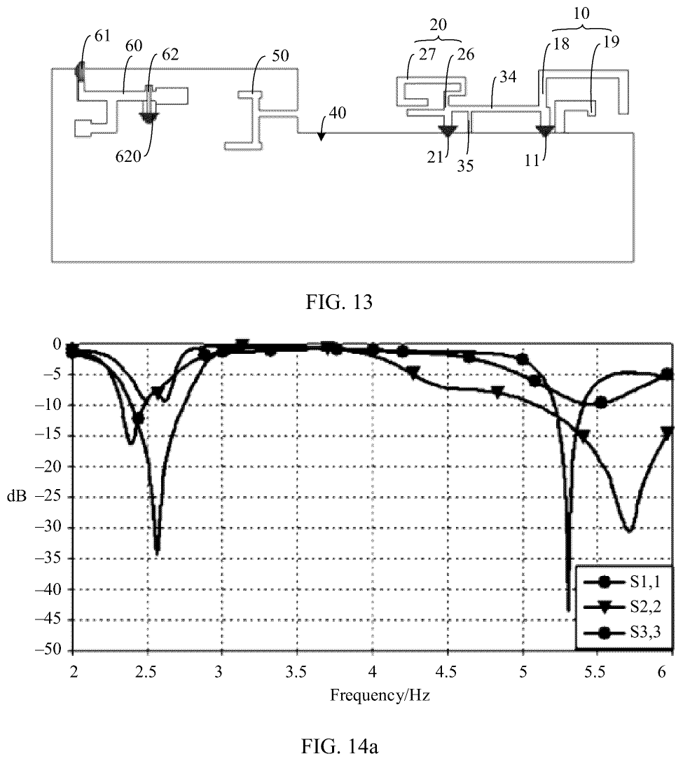

FIG. 13 is a diagram of a structure of another antenna according to an embodiment of this application. Refer to FIG. 13. When the first antenna element and the second antenna element in this application are dual-band monopole antennas, the antenna further includes a slot antenna element 60 and a defected ground structure 50. The slot antenna element 60 has a feed stub 62 and an end inductor 61. The feed stub 62 has a third feed point 620. The slot antenna element 60 can directly feed power through the third feed point 620. The slot antenna element 60 and the defected ground structure 50 are formed through etching on the ground plane 40. Adjusting a value of the end inductor 61 can adjust a low-frequency 2.4 G frequency offset of the slot antenna element 60. The defected ground structure 50 has a band-stop characteristic. Adjusting a size of the defected ground structure 50 can improve low-frequency isolation between the slot antenna element 60 and both the first antenna element 10 and the second antenna element 20.

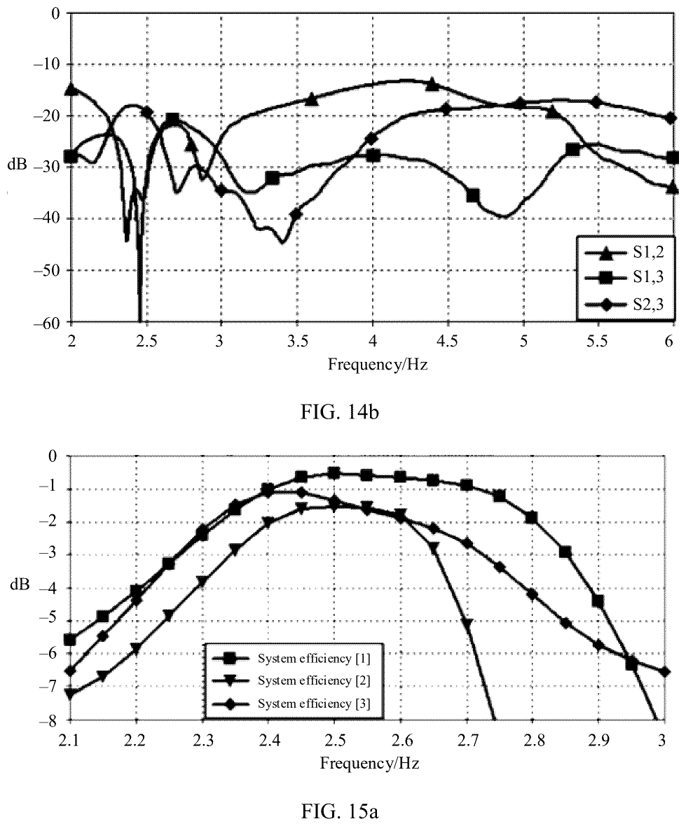

FIG. 14a is a parameter diagram of the first antenna element, the second antenna element, and the slot antenna element in FIG. 13. FIG. 14b is a parameter diagram of isolation between the first antenna element, the second antenna element, and the slot antenna element in FIG. 13. In FIG. 14b, S1,2 is a parameter diagram of the isolation between the first antenna element and the second antenna element, S1,3 is a parameter diagram of isolation between the first antenna element and the slot antenna element, and S2,3 is a parameter diagram of isolation between the second antenna element and the slot antenna element. Refer to FIG. 14b. The isolation between the first antenna element and the second antenna element and the isolation between the first antenna element and the slot antenna element within a frequency band of 2.4 GHz to 2.5 GHz are at least 30 dB, the isolation between the second antenna element and the slot antenna element within the frequency band of 2.4 GHz to 2.5 GHz is greater than 18 dB, and the isolation between the first antenna element, the second antenna element, and the slot antenna element within a frequency band of 5 GHz to 6 GHz is greater than 17 dB.

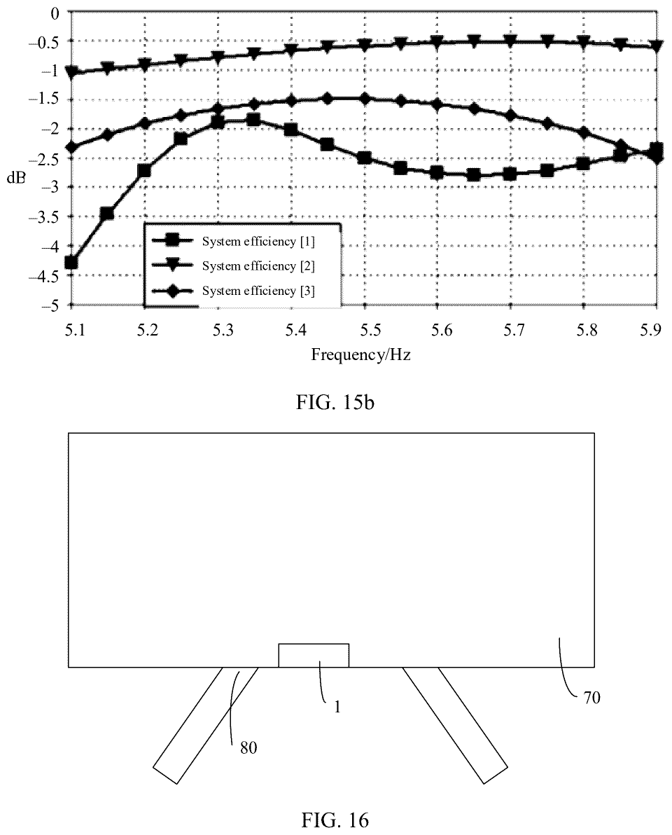

FIG. 15a is an efficiency parameter diagram of the first antenna element, the second antenna element, and the slot antenna element within a frequency band of 2.1 GHz to 3 GHz. FIG. 15b is an efficiency parameter diagram of the first antenna element, the second antenna element, and the slot antenna element within a frequency band of 5.15 GHz to 5.85 GHz. In FIG. 15a and FIG. 15b, [1] represents the first antenna element, [2] represents the second antenna element, and [3] represents the slot antenna element. It can be learned from FIG. 15a and FIG. 15b that the first antenna element, the second antenna element, and the slot antenna element have efficiency greater than −2.0 dB within the frequency band of 2.4 GHz to 2.5 GHz, and have efficiency greater than −3.5 dB within the frequency band of 5.15 GHz to 5.85 GHz. This ensures radio frequency transmission efficiency of the antenna provided in this application.

This application further provides a communication device. The communication device includes the antenna in any one of the foregoing technical solutions. When the antenna includes a first antenna element and a second antenna element, the first antenna element and the second antenna element are respectively a wireless fidelity antenna element and a Bluetooth antenna element. Because the first antenna element is connected to the second antenna element through a connection structure, coexistence interference between the wireless fidelity antenna element and the Bluetooth antenna element can be reduced, so that the wireless fidelity antenna element and the Bluetooth antenna element are independent antennas, to improve a throughput rate of the wireless fidelity antenna element in a weak field. When the antenna further includes a slot antenna element and a defected ground structure, the slot antenna element may be a wireless fidelity antenna element. In this case, the communication device includes two wireless fidelity antenna elements and one Bluetooth antenna element. For a disposition form of the two wireless fidelity antenna elements and the one Bluetooth antenna element, refer to FIG. 13. The first antenna element 10 is the Bluetooth antenna element, the second antenna element 20 is one of the wireless fidelity antenna elements, and the slot antenna element 60 is the other of the wireless fidelity antenna elements.

Refer to FIG. 16. The communication device in this application may be specifically a smart screen, a notebook computer, or the like. When the communication device is a smart screen, the smart screen includes a main screen 70 and a bracket 80. The bracket 80 is configured to support the main screen 70. The antenna 1 may be disposed on a side that is of the smart screen 70 and that is close to the bracket 80.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An antenna, comprising:
a first antenna element and a second antenna element each having a feed point; and
a connection structure, wherein the connection structure connects the first antenna element to the second antenna element, the connection structure is extendable in a direction perpendicular to a connection direction of the first antenna element and the second antenna element, and the connection structure adjusts isolation between the first antenna element and the second antenna element through extension.

2. The antenna according to claim 1, wherein the connection structure comprises a first series stub and a second series stub; and
the first series stub and the second series stub are disposed in parallel, and two ends of each of the first series stub and the second series stub are respectively connected to the first antenna element and the second antenna element, wherein
a vertical distance between the first series stub and the second series stub is adjustable.

3. The antenna according to claim 2, wherein the connection structure further comprises a first parallel stub, one end of the first parallel stub is connected to the first series stub, an other end of the first parallel stub is connected to the second series stub, and a length of the first parallel stub in a vertical direction between the first series stub and the second series stub is adjustable.

4. The antenna according to claim 3, wherein a first capacitor is disposed on the first parallel stub, and a capacitance value of the first capacitor is adjustable.

5. The antenna according to claim 2, wherein the first antenna element comprises a first radiator, a second radiator, and a third radiator, a first end and a second end of the second radiator are respectively connected to the first radiator and the third radiator, the first radiator and the third radiator are disposed in parallel on a same side of the second radiator, and the feed point of the first antenna element is disposed on the second radiator;
the second antenna element comprises a fourth radiator, the fourth radiator and the second radiator are disposed in parallel, the fourth radiator is located on a side that is of the second radiator and that is away from the first radiator and the third radiator, and the feed point of the second antenna element is disposed on the fourth radiator; and
the two ends of each of the first series stub and the second series stub are respectively connected to the second radiator and the fourth radiator.

6. The antenna according to claim 1, wherein the antenna further comprises a ground plane, the first antenna element and the second antenna element are connected to the ground plane through the respective feed points; and
the connection structure comprises a third series stub and a second parallel stub, two ends of the third series stub are respectively connected to the first antenna element and the second antenna element, one end of the second parallel stub is connected to the third series stub, an other end of the second parallel stub is connected to the ground plane, and a length of the second parallel stub in a vertical direction from the third series stub to the ground plane is adjustable.

7. The antenna according to claim 6, wherein a second capacitor is disposed on the second parallel stub, and a capacitance value of the second capacitor is adjustable.

8. The antenna according to claim 6, wherein the first antenna element comprises a fifth radiator, a sixth radiator, and a seventh radiator, one end of the fifth radiator is located at a first end of the sixth radiator, one end of the seventh radiator is at a position between the first end and a second end of the sixth radiator, the seventh radiator and the fifth radiator are disposed in parallel and extend in opposite directions, and an other end of the seventh radiator is connected to the ground plane through the feed point of the first antenna element;
the second antenna element comprises an eighth radiator, a ninth radiator, and a tenth radiator, one end of the ninth radiator is located at a first end of the eighth radiator, one end of the tenth radiator is at a position between the first end of the eighth radiator and a second end of the eighth radiator, the ninth radiator and the tenth radiator are disposed in parallel and extend in a same direction, and an other end of the tenth radiator is connected to the ground plane through the feed point of the second antenna element; and
the third series stub is connected to the second end of the sixth radiator and the second end of the eighth radiator.

9. The antenna according to claim 6, wherein the first antenna element comprises an eleventh radiator and a twelfth radiator, one end of the eleventh radiator and one end of the twelfth radiator are separately connected to the ground plane, and the feed point of the first antenna element is disposed at a joint between the eleventh radiator and the ground plane;
the second antenna element comprises a thirteenth radiator and a fourteenth radiator, a first end of the thirteenth radiator is connected to the ground plane, a second end of the thirteenth radiator is connected to the fourteenth radiator, the feed point of the second antenna element is disposed at a joint between the first end of the thirteenth radiator and the ground plane, and the eleventh radiator is located between the twelfth radiator and the thirteenth radiator; and
the third series stub is connected to the thirteenth radiator and the eleventh radiator.

10. The antenna according to claim 9, further comprising a slot antenna element with a feed point and a defected ground structure, wherein the defected ground structure is formed on the ground plane, and the defected ground structure is configured to adjust isolation between the slot antenna element and both the first antenna element and the second antenna element.

11. A communication device, comprising an antenna, the antenna comprises:
a first antenna element and a second antenna element each having a feed point; and
a connection structure, wherein the connection structure connects the first antenna element to the second antenna element, the connection structure is extendable in a direction perpendicular to a connection direction of the first antenna element and the second antenna element, and the connection structure adjusts isolation between the first antenna element and the second antenna element through extension.

12. The communication device according to claim 11, wherein the connection structure comprises a first series stub and a second series stub; and
the first series stub and the second series stub are disposed in parallel, and two ends of each of the first series stub and the second series stub are respectively connected to the first antenna element and the second antenna element, wherein
a vertical distance between the first series stub and the second series stub is adjustable.

13. The communication device according to claim 12, wherein the connection structure further comprises a first parallel stub, one end of the first parallel stub is connected to the first series stub, an other end of the first parallel stub is connected to the second series stub, and a length of the first parallel stub in a vertical direction between the first series stub and the second series stub is adjustable.

14. The communication device according to claim 13, wherein a first capacitor is disposed on the first parallel stub, and a capacitance value of the first capacitor is adjustable.

15. The communication device according to claim 12, wherein the first antenna element comprises a first radiator, a second radiator, and a third radiator, a first end and a second end of the second radiator are respectively connected to the first radiator and the third radiator, the first radiator and the third radiator are disposed in parallel on a same side of the second radiator, and the feed point of the first antenna element is disposed on the second radiator;
the second antenna element comprises a fourth radiator, the fourth radiator and the second radiator are disposed in parallel, the fourth radiator is located on a side that is of the second radiator and that is away from the first radiator and the third radiator, and the feed point of the second antenna element is disposed on the fourth radiator; and
the two ends of each of the first series stub and the second series stub are respectively connected to the second radiator and the fourth radiator.

16. The communication device according to claim 11, wherein the antenna further comprises a ground plane, the first antenna element and the second antenna element are connected to the ground plane through the respective feed points; and
the connection structure comprises a third series stub and a second parallel stub, two ends of the third series stub are respectively connected to the first antenna element and the second antenna element, one end of the second parallel stub is connected to the third series stub, an other end of the second parallel stub is connected to the ground plane, and a length of the second parallel stub in a vertical direction from the third series stub to the ground plane is adjustable.

17. The communication device according to claim 16, wherein a second capacitor is disposed on the second parallel stub, and a capacitance value of the second capacitor is adjustable.

18. The communication device according to claim 16, wherein the first antenna element comprises a fifth radiator, a sixth radiator, and a seventh radiator, one end of the fifth radiator is located at a first end of the sixth radiator, one end of the seventh radiator is at a position between the first end and a second end of the sixth radiator, the seventh radiator and the fifth radiator are disposed in parallel and extend in opposite directions, and an other end of the seventh radiator is connected to the ground plane through the feed point of the first antenna element;
the second antenna element comprises an eighth radiator, a ninth radiator, and a tenth radiator, one end of the ninth radiator is located at a first end of the eighth radiator, one end of the tenth radiator is at a position between the first end of the eighth radiator and a second end of the eighth radiator, the ninth radiator and the tenth radiator are disposed in parallel and extend in a same direction, and an other end of the tenth radiator is connected to the ground plane through the feed point of the second antenna element; and
the third series stub is connected to the second end of the sixth radiator and the second end of the eighth radiator.

19. The communication device according to claim 16, wherein the first antenna element comprises an eleventh radiator and a twelfth radiator, one end of the eleventh radiator and one end of the twelfth radiator are separately connected to the ground plane, and the feed point of the first antenna element is disposed at a joint between the eleventh radiator and the ground plane;
the second antenna element comprises a thirteenth radiator and a fourteenth radiator, a first end of the thirteenth radiator is connected to the ground plane, a second end of the thirteenth radiator is connected to the fourteenth radiator, the feed point of the second antenna element is disposed at a joint between the first end of the thirteenth radiator and the ground plane, and the eleventh radiator is located between the twelfth radiator and the thirteenth radiator; and
the third series stub is connected to the thirteenth radiator and the eleventh radiator.

20. The communication device according to claim 19, wherein the antenna further comprises a slot antenna element with a feed point and a defected ground structure, wherein the defected ground structure is formed on the ground plane, and the defected ground structure is configured to adjust isolation between the slot antenna element and both the first antenna element and the second antenna element.
